(19) United States
(12) Patent Application Publication
(10) Pub. No.: US 2006/0271445 A1
(43) Pub. Date: Nov. 30, 2006

(54) Electronic commerce method over wireline/wireless network environments

(75) Inventors: Min-Hwa Lee, Seoul (KR); Houn-Su Lee, Seoul (KR)

Correspondence Address: JENKENS & GILCHRIST, P.C., 901 15TH STREET N.W., SUITE 900, WASHINGTON, DC, 20005, US

(73) Assignee: Healthpia America, Co., Ltd., Palisades, NJ (US)

(21) Appl. No.: 11/441,444

(22) Filed: May 26, 2006

Related U.S. Application Data
(63) Continuation of application No. PCT/KR04/03096, filed on Nov. 27, 2004.

(30) Foreign Application Priority Data
Nov. 27, 2003 (KR) 10-2003-0085042
Jun. 2, 2004 (KR) 10-2004-0040087

(51) Int. Cl. G06Q 30/00

(52) U.S. Cl. 705/26

(57) ABSTRACT

Disclosed is an electronic commerce method over wireline/wireless networks and, more particularly, a shopping mall operating system accessible over the wireline and wireless Internet. The electronic commerce method in accordance with the present invention allows a user to purchase healthcare goods conveniently and constantly. In addition, the electronic commerce method in accordance with the present invention allows a user to conveniently purchase consumables, which are to be frequently purchased, upon accessing a mobile communication network by making it possible to set the consumables to be purchased over the wireless network in advance upon accessing the wireline network. Accordingly, the user can conveniently purchase goods anytime and anywhere through the wireline Internet and the mobile communication network.

### FIELD OF THE INVENTION

The present invention relates to an electronic commerce method over wireline/wireless networks and, more particularly, to a method of allowing a user to conveniently purchase healthcare goods in a shopping mall system accessible over both wireline and wireless networks.

### BACKGROUND OF THE INVENTION

Shopping malls accessible over a wireline Internet have been widely used until now. Web shopping malls have gained popularities among users since they allow the users to view goods information easily, to compare prices easily, and to purchase goods conveniently. On the contrary, shopping using a mobile communication terminal has not been widely used and its main reason is that it is difficult to obtain sufficient information about goods due to the limitation of speed or terminal.

On the other hand, in case of consumables, it is troublesome to boot a computer and access a shopping mall on a web site each time a user desires to purchase goods.

For instance, customers who have purchased blood glucose meters should frequently access shopping malls on web sites to purchase consumables such as blood sugar strips. While managing a business associated with the blood glucose meter, the present inventor has conceived of the idea of minimizing the number of times the customers access the shopping malls for the purposes of allowing the customers to conveniently purchase consumables such as blood sugar strips.

On the other hand, users (or patients) desire to make a medical measurement and to take a medical treatment without the need to visit hospitals.

To meet the desire of the users, a new healthcare technology has been developed. For example, the healthcare technology is briefly described as follows. That is, a communication is established between a user terminal and a healthcare server. Medical data measured by the user terminal is sent to the healthcare server. The healthcare server maintains each user's measurement history information and sends to the user terminal a signal to instruct to take an expert treatment. At this time, the healthcare server can offer a measurement result to an expert for the purpose of analysis or analyze the measurement result using an expert analysis system.

With the help of such a healthcare technology, the user can monitor his/her physical conditions and take a professional medical treatment constantly and conveniently.

In recent years, a mobile communication terminal, such as cellular phone, equipped with medical measurement and treatment functions has been put on the market. The mobile communication terminal is typically provided with a user interface and a communication function. In addition, the mobile communication terminal can be equipped with treatment/measurement application programs and have a battery pack equipped with treatment/measurement circuits. Thus, users can conveniently make a medical measurement and take a medical treatment anytime and anywhere.

In addition, examples of such a mobile communication terminal include a mobile terminal with a blood glucose meter, a mobile terminal with an insulin pump, etc.

On the other hand, in order for a user to make a medical measurement or to take a medical treatment, necessary healthcare consumables should be constantly provided to the user.

For example, in case of the mobile terminal with a blood glucose meter, blood sugar test strips should be constantly provided to the user. In case of the mobile terminal with an insulin pump, insulin should be constantly supplied for diabetic treatment.

On the other hand, in case of health management using digital technology, an additional user terminal (wireline or wireless terminal) is typically needed and thus healthcare consumables suitable for the user terminal may be required.

Currently, drugstores mainly sell healthcare consumables available offline. Thus, it is difficult to purchase the healthcare consumables according to the present invention at the drugstores on the street.

In addition, since old-aged people who are much interested in healthcare have a great difficulty in using the Internet well, it is not possible to provide the healthcare consumables to sellers or users constantly and conveniently through a current online purchase method.

### SUMMARY OF THE INVENTION

The present invention has been made in view of the above problems, and it is an object of the present invention to provide an electronic commerce method over wireline/wireless networks which is capable of simplifying a purchasing procedure conducted in purchasing goods in a shopping mall.

It is another object of the present invention to provide an electronic commerce method over wireline/wireless networks which is capable of combining the advantage of a web shopping mall using a wireline Internet with the mobility of a mobile communication network.

It is yet another object of the present invention to provide an electronic commerce method over wireline/wireless networks which is capable of conveniently purchasing consumables through a mobile communication terminal.

It is yet another object of the present invention to provide a method of conveniently supplying goods to a user in a healthcare system combined with digital technology.

It is yet another object of the present invention to allow a user to make a prediction about when to purchase goods so that he/she can purchase healthcare goods in advance.

It is yet another object of the present invention to provide a method of allowing a user to conveniently purchase healthcare goods anywhere and anytime.

It is yet another object of the present invention to provide a method of estimating the amount of stock of each user, inducing the user to purchase goods using his/her mobile communication terminal, and allowing the user to conveniently purchase the goods using the mobile communication terminal without complicated purchase procedures.

In accordance with an aspect of the present invention, a shopping mall system employing an electronic commerce method over wireline/wireless networks is implemented in a shopping mall system accessible over both a wireline Internet and a mobile communication network.

The shopping mall system may be configured to divided into a system accessed over a wireline Internet and a system accessed over a mobile communication network. Alternatively, the shopping mall system may be configured to have different network paths therein.

In accordance with another aspect of the present invention, an electronic commerce method over wireline/wireless networks allows a user accessing over the wireline network to create a list of goods to be purchased over a mobile communication network, and to conveniently purchase desired goods upon accessing over the mobile communication network by selecting the desired goods among the list.

Accordingly, the electronic commerce method in accordance with the present invention has an advantage in that it is possible to decide whether or not to purchase goods through a comparison of a number of goods in a web shopping mall, and, once decided, to conveniently purchase the goods through the mobile communication terminal anywhere and anytime.

In accordance with yet another aspect of the present invention, an electronic commerce method over wireline/wireless networks is characterized in that a user is authenticated through a phone number of a mobile communication terminal upon purchasing goods using the mobile communication terminal.

Accordingly, the electronic commerce method in accordance with the present invention has an advantage in that it is possible to authenticate a user accessing over a mobile communication network without an additional login process.

In accordance with yet another aspect of the present invention, an electronic commerce method over wireline/wireless networks is characterized in that information required in purchasing goods over a mobile communication network, such as payment means and delivery destination, is inputted in advance upon accessing a web shopping mall.

Accordingly, the electronic commerce method in accordance with the present invention has an advantage in that it facilitates shopping in a mobile communication terminal under a relatively limited user interface environment.

In accordance with yet another aspect of the present invention, an electronic commerce method over wireline/wireless networks is characterized in that the amount of stock of each user is estimated from goods usage amount information. For instance, if an estimated amount of stock satisfies a predetermined condition, an inducing signal to induce a user to purchase corresponding goods is sent to the user's mobile communication terminal. The inducing signal may be a short text message containing an address required in accessing a server on a network. For example, when the user inputs a key corresponding to a purchase order in response to the inducing signal, a reply signal to the inducing signal is sent from the mobile communication terminal to the server. At this time, a communication connection is preferably established between the mobile communication terminal and the server. Once the reply signal is received from the mobile communication terminal, the server performs a selling process of the ordered goods using personal information stored therein.

Accordingly, a user admitted to a healthcare program can conveniently purchase desired goods without the need to take stock of his/her goods as long as he/she replies to the inducing signal.

That is, it is not necessary for the user to go out to purchase goods, or to access any wireline/wireless web server using a terminal (personal computer, mobile communication terminal, etc.) to purchase goods. In this case, although the mobile communication terminal is used to purchase goods, the present invention is characterized in that it does not take complex procedures or long times to purchase goods compared to conventional methods. That is, the mobile communication terminal is used only in placing a purchase order of goods based on stocktaking. In addition, for example, the personal information required for mobile payment is entered in advance when a user makes an application for membership admission. Thus, it is not necessary to enter the personal information again upon purchasing goods.

Accordingly, the present invention can be efficiently utilized by old-aged people who are much interested in healthcare. In particular, since healthcare consumables are purchased repeatedly, the present invention can be more efficiently utilized.

In accordance with yet another aspect of the present invention, the goods usage amount information is transmitted from a member's terminal to the healthcare server and is obtained from a signal generated when the healthcare consumables are consumed.

Accordingly, the goods usage amount information can be obtained through various means.

The healthcare server and the member's terminal transmit/receive signals associated with medical measurement or medical treatment to each other. In an embodiment of the present invention, the goods usage amount information can be obtained using an instruction signal, which is issued by the healthcare server, to instruct to use the healthcare consumables.

In accordance with yet another aspect of the present invention, the present invention is characterized in that the goods usage amount information is transmitted from the healthcare server to a mobile communication terminal of a corresponding member and is obtained from an instruction signal to instruct to use the healthcare consumables.

In another embodiment of the present invention, the goods usage amount information can be obtained from a signal generated by a mobile communication terminal by using the healthcare consumables.

From this point of view, the above-mentioned features specify specific technologies of the healthcare business (combined with digital technology) to which the present invention can be applied. In addition, the present invention can be applied in such a specific technical configuration.

In accordance with yet another aspect of the present invention, the present invention is characterized in that the member's terminal is a mobile communication terminal.

In the present invention, the user's terminal accessing to the healthcare server may be a wireline terminal or wireless terminal. It is desired that the user's terminal is a mobile communication terminal.

To use a healthcare service anytime and anywhere, a user's terminal tends to be implemented with a mobile wireless terminal. In recent years, a configuration for medical treatment or medical measurement tends to be combined with a mobile phone. Accordingly, the present invention can be also applied to a case where the member's terminal is a mobile communication terminal.

In addition, the healthcare goods available in a mobile communication terminal can be difficult to find at shopping malls on the street. However, according to the present invention, the user can conveniently purchase such healthcare goods.

In accordance with yet another aspect of the present invention, the goods usage amount information is obtained from the usage cycle of the healthcare consumables.

That is, the usage amount may be determined depending on the usage cycle of the healthcare consumables.

### BRIEF DESCRIPTION OF THE DRAWINGS

The above and other features and advantages of the present invention will become more apparent by describing in detail exemplary embodiments thereof with reference to the attached drawings in which:

FIG. 1 shows an embodiment of a system employing an electronic commerce method over wireline/wireless networks in accordance with the present invention;

FIG. 2 shows another embodiment of a system employing an electronic commerce method over wireline/wireless networks in accordance with the present invention;

FIG. 3 is a view showing an electronic commerce method over wireline/wireless networks in accordance with an embodiment of the present invention which can be implemented in the system shown in FIG. 1;

FIG. 4 is a view showing an electronic commerce method over wireline/wireless networks in accordance with an embodiment of the present invention which can be implemented in the system shown in FIG. 2;

FIG. 5 is a block diagram showing a system employing the present invention;

FIG. 6 is a view showing goods sale/purchase methods in accordance with a preferred embodiment of the present invention; and

FIG. 7 shows an example of a message displayed in a display of a mobile communication terminal in accordance with a preferred embodiment of the present invention.

### DETAILED DESCRIPTION OF THE PREFERRED EMBODIMENT

Exemplary embodiments in accordance with the present invention will now be described in detail with reference to the accompanying drawings. In the drawings, the same elements are denoted by the same reference numerals even though they are depicted in different drawings.

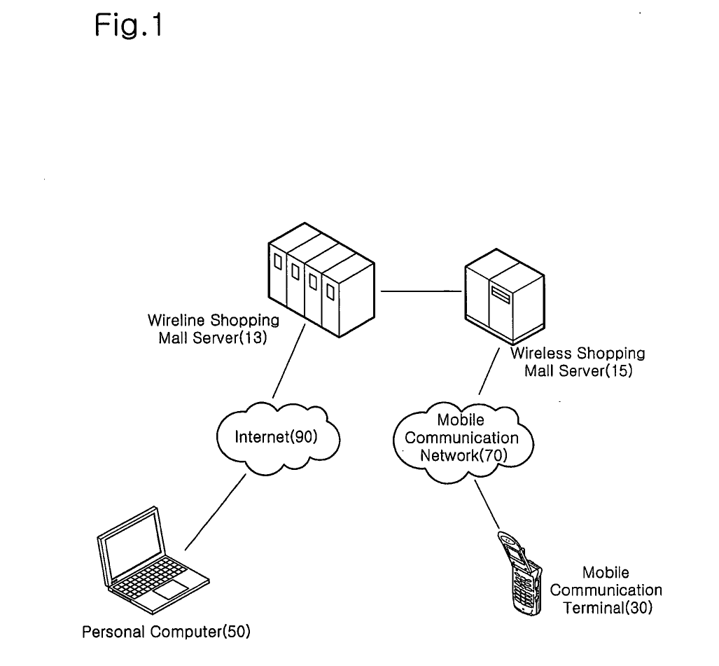

FIG. 1 shows an embodiment of a system employing an electronic commerce method over wireline/wireless networks in accordance with the present invention. As shown in FIG. 1, a shopping mall system in accordance with the present invention comprises a wireline shopping mall server 13 accessible from a number of personal computers 50 over the Internet 90, and a wireless shopping mall server 15 accessible from a number of mobile communication terminals 30 over a mobile communication network 70.

In the present invention, the mobile communication network 70 refers to a wireless Internet network for data communication as well as voice communication. For example, in a 3GPP2 network, a mobile communication terminal is connected to a PDSN (packet data service node) through a RAN (radio access network) comprising a BTS (base transceiver station), a BSC (base station controller), and a PCF (packet control function). At this time, the RAN is responsible for the basic authentication and mobility management of a data call. Dynamic assignment and connection of IP is managed by DHCP (dynamic host configuration protocol)/DNS (domain name system) servers. The wireless shopping mall server 15 transmits/receives IP packets to/from the PDSN in the 3GPP2 network. Packet communication technology in such a mobile communication network is well known in the art and thus a detailed description thereof will not be given herein.

The mobile communication terminal 30 refers to a terminal accessible to the Internet over a mobile communication network. Examples of the mobile communication terminal 30 include a mobile phone, a cellular phone, and a PDA (personal digital assistant).

The wireline shopping mall server 13 can be accessed through the personal computer 50 over a typical Internet network. The wireline shopping mall server 13 and the wireless shopping mall server 15 are connected to each other through a typical TCP/IP network. Both of them may be connected to each other over LAN (local area network) or WAN (wide area network).

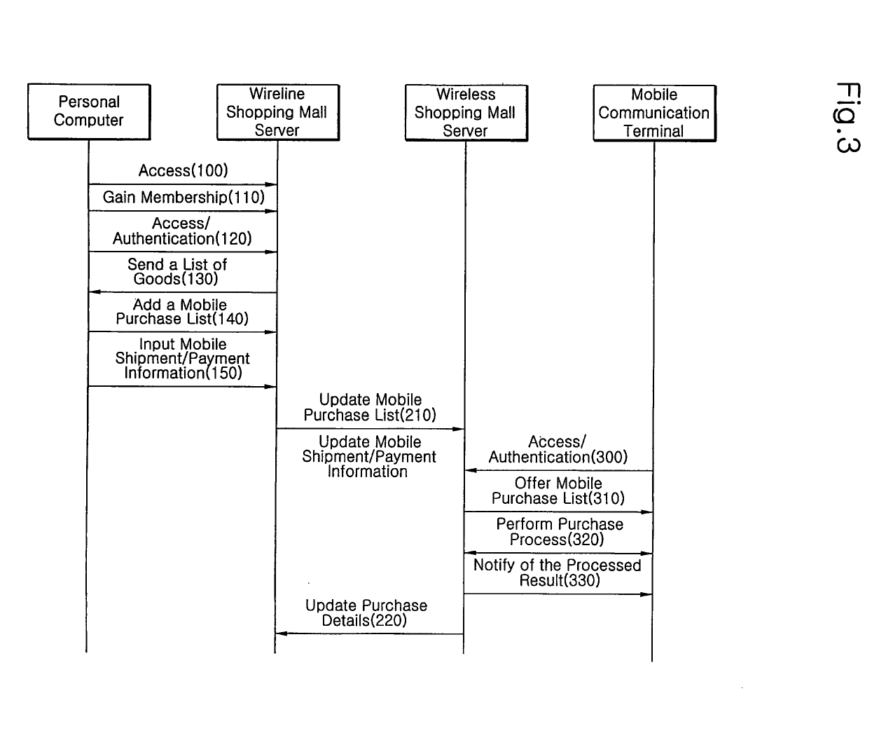

FIG. 3 is a view showing an electronic commerce method over wireline/wireless networks in accordance with an embodiment of the present invention which can be implemented in the system shown in FIG. 1. The electronic commerce method over wireline/wireless networks in accordance with the present invention can be implemented in both the wireline shopping mall system on the wireline Internet and the wireless shopping mall system which is linked with the wireline shopping mall system and is accessible over the mobile communication network.

The electronic commerce method comprises the steps of authenticating a user accessing the wireline shopping mall by the wireline shopping mall server (step 120); allowing the wireline shopping mall server to offer goods information to the user and to receive selection information from the user and adding the selection information to a list of goods to be purchased through the wireless shopping mall (steps 130 and 140); allowing the wireless shopping mall server to process a connection with the mobile communication terminal (step 300); allowing the wireless shopping mall server to transmit the list of goods to the mobile communication terminal (step 310); and performing a purchasing process of selected goods by the wireless shopping mall server (step 320). This will now be described in more detail.

In one implementation, a user executes a web browser on his/her personal computer and accesses the wireline shopping mall server (step 100). Subsequently, the user fills in a web page form offered by the wireline shopping mall server with his/her personal information, and the wireline shopping mall server registers the user as a member with reference to the information (step 110). The present invention is characterized in that the wireline shopping mall system receives membership information including a phone number of a mobile communication terminal and performs a membership admission process. The phone number plays a key role in linking the wireline shopping mall with the wireless shopping mall. Once the membership admission process is completed, the user can access the system and be authenticated through his/her membership ID (step 120).

Next, when a member selects a purchase page in the wireline shopping mall, a list of goods is sent to the member (step 130). The terminal receives goods information from the wireline shopping mall server and displays it to the user. Then, the terminal receives information inputted by the user and transmits it to the wireline shopping mall server as selection information about goods to be purchased through the wireless shopping mall. In addition, the member can purchase goods in the wireline shopping mall and ask to deliver the goods, while the wireline shopping mall server can perform such a purchase process.

In addition, the wireline shopping mall server can receive in advance delivery and payment information to be used in the wireless shopping mall and set the information for a user (step 150). For instance, a goods purchase process in the wireline shopping mall server further comprises a payment means selection step where the wireline shopping mall server offers the user a list of payment means to be used in purchasing goods in the wireless shopping mall, receives selection information inputted by the user, and stores the selection information as payment means to be used in purchasing goods in the wireless shopping mall.

The list of goods to be purchased in the wireless shopping mall and the payment/delivery information, which are set for mobile purchase, are transmitted from the wireline shopping mall server to the wireless shopping mall server (step 210).

Next, the user accesses the wireless shopping mall server through the mobile communication terminal rather than his/her personal computer and is authenticated (step 300). The wireless shopping mall server authenticates the user accessing through the mobile communication terminal. The present invention is characterized in that the goods purchase process performed by the wireless shopping mall server comprises a membership authentication step where it is verified whether or not a user is a member through a phone number of an accessed mobile communication terminal. That is, when a phone number of an originating terminal which is sent from a mobile switching center is transmitted to the wireless shopping mall server through the PDSN, a user authentication process is performed using the phone number.

In one implementation, an access to the wireless shopping mall server is controlled by software equipped in the mobile communication terminal. For example, in a mobile communication terminal equipped with a blood glucose meter, the terminal contains a blood sugar test menu which further includes a shopping menu in addition to a menu associated with the measurement. Accordingly, when selecting the shopping menu, the user can access the wireless shopping mall server over the wireless Internet network.

Subsequently, when the wireless shopping mall server sends the list of goods to be purchased in the wireless shopping mall, the terminal receives and displays it (step 310). When the terminal transmits, to the wireless shopping mall server, purchase order information about goods selected by the user among the list of goods displayed on the terminal, the wireless shopping mall server receives it and performs a purchase process of the selected goods (step 320). The purchase process comprises the steps of placing an order of the selected goods, performing a payment process, and transmitting delivery information to a delivery company. At this time, the present invention is characterized in that the payment/delivery information inputted upon accessing the wireline shopping mall is used. In addition, prior to the payment process, a final verification process of a user can be conducted. The final verification process may include an additional authentication process for the payment means, such as a request to type in something like his/her password to a credit card or bank account.

Upon completion of the purchase process, when the wireless shopping mall server summarizes a result of the purchase process, such as ordered goods, payment details, and delivery destination, and sends the result to the terminal, the terminal receives and displays it on a display (step 330). Thus, the user can confirm the purchase information about his/her goods which has been previously inputted.

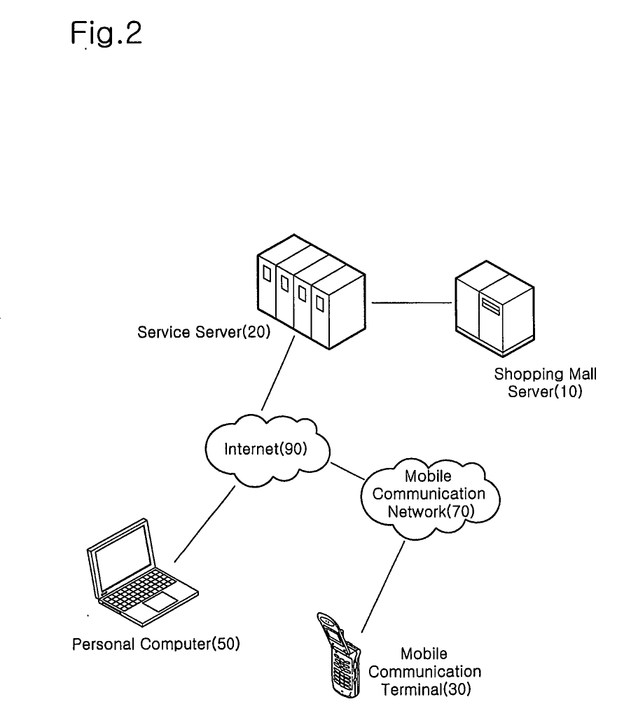

FIG. 2 shows another embodiment of a system employing an electronic commerce method over wireline/wireless networks in accordance with the present invention. As shown in FIG. 2, a shopping mall system in accordance with the present invention comprises a shopping mall server 10 accessible from a number of personal computers 50 over the Internet 90 and from a number of mobile communication terminals 30 over a mobile communication network 70. In the present embodiment, a description will be given of a shopping mall and service associated with a blood glucose meter. However, the present invention should not be limited thereto but can be also applied to ordinary goods, especially to consumables which need to be repeatedly purchased.

The mobile communication terminal 30 refers to a terminal accessible to the Internet over a mobile communication network. Examples of the mobile communication terminal 30 include a mobile phone, a cellular phone, and a PDA (personal digital assistant). In the present embodiment, the mobile communication terminal 30 may be configured so that it has a battery pack equipped with a blood glucose meter which can be communicated with a main body equipped with a program controlling the blood glucose meter and measured blood sugar data is maintained in a service server 20 through the wireless Internet. The present applicant has filed a patent application for the mobile communication terminal having such configuration, which is Korean Patent Application No. 2002-0026511, to the Korean Intellectual Property Office on May 14, 2002.

The service server 20 maintains blood sugar data measured in the mobile communication terminal, analyzes the measured data, makes up the prescription, and offers healthcare information relating to blood sugar management.

While the shopping mall server 10 is connected to the wireless Internet 90, IP packets may be routed from the PDSN of the mobile communication terminal 70. The shopping mall server 10, for example, can be configured to include a process offering a WAP page for an access from the mobile communication terminal 30 and another process offering a Web page for an access from the personal computer 50.

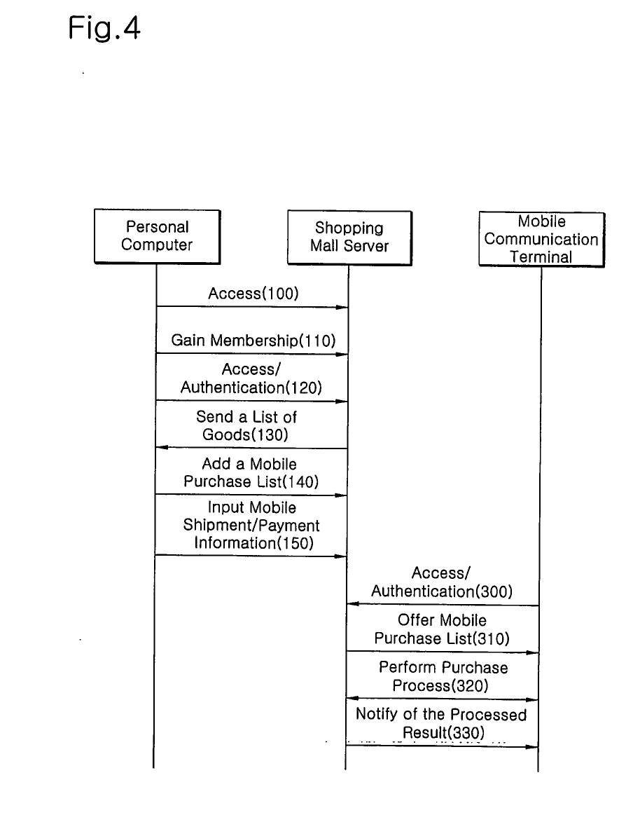

FIG. 4 is a view showing an electronic commerce method over wireline/wireless networks in accordance with an embodiment of the present invention which can be implemented in the system shown in FIG. 2. Those similar to steps in FIG. 3 are denoted by the same reference numerals.

The electronic commerce method over wireline/wireless networks in accordance with the present invention can be implemented in a shopping mall accessible over both the wireline Internet and the mobile communication network. The electronic commerce method comprises the steps of offering a web page for user authentication to a user's computer accessing over the wireline Internet and performing an authentication process with reference to information received from the user 120; offering a web page containing goods information to the user and adding selection information received from the user to a list of goods to be purchased over the wireless network (steps 130 and 140); accessing to the user's mobile communication terminal over the wireless network (step 300); transmitting to the mobile communication terminal the list of goods to be purchased over the wireless network (step 310); and performing a purchasing process of corresponding goods in response to the user's selection (step 320). This will now be described in more detail.

In one implementation, a user executes a web browser on his/her personal computer and accesses the shopping mall server according to the present invention (step 100). Subsequently, the user fills in a web page form offered by the shopping mall server with his/her personal information, and the shopping mall server registers the user as a member with reference to the information (step 110). The present invention is characterized in that the shopping mall system receives membership information including a phone number of a mobile communication terminal and performs a membership admission process. The phone number plays a key role in authenticating the user accessing over the mobile communication network. Once the membership admission process is completed, the user can access the system and be authenticated through his/her membership ID (step 120).

In one implementation, a shopping mall may be a homepage for diabetic patients. This homepage may be one for providing a service to a user who has purchased a mobile communication terminal having diabetic measurement function. This homepage provides information concerning diabetic treatment and a history of blood sugar test, and an analysis report offered by an expert system on the basis of this information. In addition, this homepage can provide shopping mall pages which allow a user to purchase goods necessary to the diabetic patients. For example, the homepage provides links which allow a user to purchase blood glucose meter, blood collection needle, blood collection device, strip, insulin pump, insulin syringe, etc., and provides various goods according to the price and manufacturer. When a certain link is selected, goods information, such as goods photograph, price, specification, manufacturer, or place of origin, is presented in graphic and text formats.

When a member selects a purchase page in the shopping mall, a list of goods is sent to the member (step 130). The terminal receives goods information from the shopping mall server and offers it to the user. Then, the terminal receives selection information inputted by the user and transmits it to the shopping mall server as selection information about goods to be purchased through the wireless network. In addition, the member can purchase goods in the shopping mall and ask to deliver the goods, and the shopping mall server can perform such a purchase process.

In addition, the shopping mall server can receive in advance delivery and payment information to be used in purchasing goods over the wireless network (step 150). For instance, a goods purchase process in the shopping mall server further comprises a payment means selection step where the shopping mall server offers the user a list of payment means to be used in purchasing goods over the wireless network, receives selection information inputted by the user, and stores the selection information as payment means to be used in purchasing goods over the wireless network.

The list of goods to be purchased through the wireless network and the payment/delivery information, which are set for mobile purchase, are stored in a database (step 210). The database can be accessed through both a shopping process through the wireline network and a shopping process through the wireless network.

Next, the user accesses the shopping mall server through the mobile communication terminal rather than his/her personal computer and is authenticated (step 300). The shopping mall server authenticates the user accessing through the mobile communication terminal. The present invention is characterized in that the goods purchase process performed by the shopping mall server comprises a membership authentication step where it is verified whether or not a user is a member through a phone number of an accessed mobile communication terminal. That is, when a phone number of an originating terminal which is sent from a mobile switching center is transmitted to the wireless shopping mall server through the PDSN, a user authentication process is performed with reference to the phone number.

In one implementation, an access to the shopping mall server is controlled by software equipped in the mobile communication terminal. For example, in a mobile communication terminal equipped with a blood glucose meter, the terminal has a blood sugar test menu which further includes a shopping menu in addition to a menu associated with the measurement. Accordingly, when selecting the shopping menu, the user can access the wireless shopping mall server over the wireless Internet network.

Subsequently, when the shopping mall server sends to the terminal a list of goods to be purchased over the wireless network, the terminal receives and displays it (step 310). For example, the user accesses a homepage over the Internet and adds blood sugar test strips and blood collection needles to the list of goods to be purchased over the wireless network. Subsequently, when the user selects a shopping menu in his/her mobile phone, a list of the two goods is displayed. Thus, the user can conveniently purchase corresponding goods by selecting them.

Next, when the terminal transmits, to the shopping mall server, purchase order information about goods selected by the user among the list of goods displayed on the terminal, the shopping mall server receives it and performs a purchase process of the selected goods (step 320). The purchase process comprises the steps of placing an order of the selected goods, performing a payment process, and transmitting delivery information to a delivery company. At this time, the present invention is characterized in that the payment/delivery information inputted upon accessing over the wireline Internet is used. In addition, prior to the payment process, a final verification process of a user can be conducted. The final verification process may include an additional authentication process for the payment means, such as a request to type in something like his/her password to a credit card or bank account.

Upon completion of the purchase process, when the shopping mall server summarizes a result of the purchase process, such as ordered goods, payment details, and delivery destination, and sends the result to the terminal, the terminal receives and displays it on a display (step 330). Thus, the user can confirm the purchase information about his/her goods which has been previously inputted.

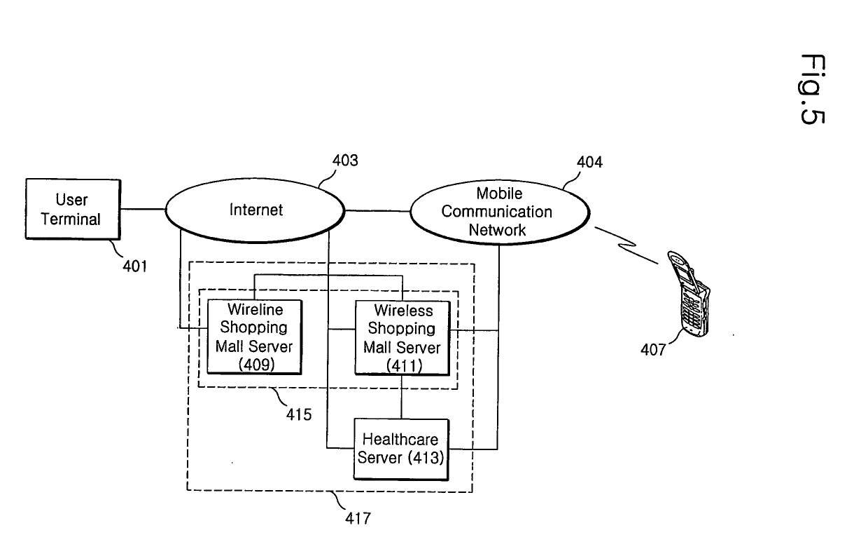

FIG. 5 is a block diagram showing a system employing the present invention.

A healthcare server 413 communicates with a wireline terminal 401 or a wireless terminal 407 (e.g., mobile communication terminal) to transmit/receive signals associated with medical measurement or medical treatment to each other. The healthcare server 413 can be implemented with a computer system, wireline/wireless Internet, and necessary software.

For example, the user terminals 401 and 407 transmit medical measurement data to the healthcare server 413. The healthcare server 413 maintains a measurement history of each user, and transmits to the user terminals 401 and 407 a signal to instruct to take an expert treatment. At this time, the healthcare server 413 can offer a measurement result to an expert for the purpose of analysis or analyze the measurement result using an expert analysis system.

In one implementation, the wireless terminal 407 may be a mobile communication terminal. The mobile communication terminal 407 may be a terminal having a blood glucose meter, or a terminal having diabetic treatment function which is equipped with an insulin pump.

The mobile communication terminal 407 is well known in the art. In addition, the mobile communication terminal 407, for example, may be a PCS (personal communications service) phone, cellular phone, or PDA. Meanwhile, the healthcare server 413 and the shopping mall server 415 can be operated in the same company. In addition, while the two servers are functionally divided (see reference numerals 413 and 415), they can be physically integrated into a single server (see reference numeral 417). A shopping mall company and a healthcare company may work in alliance with each other and operate respective servers.

In addition, the shopping mall server 415 may be divided into a wireline shopping mall server 409 and a wireless shopping mall server 411.

A detailed description will be given below of the operations of the wireline shopping mall server 409 and wireless shopping mall server 411.

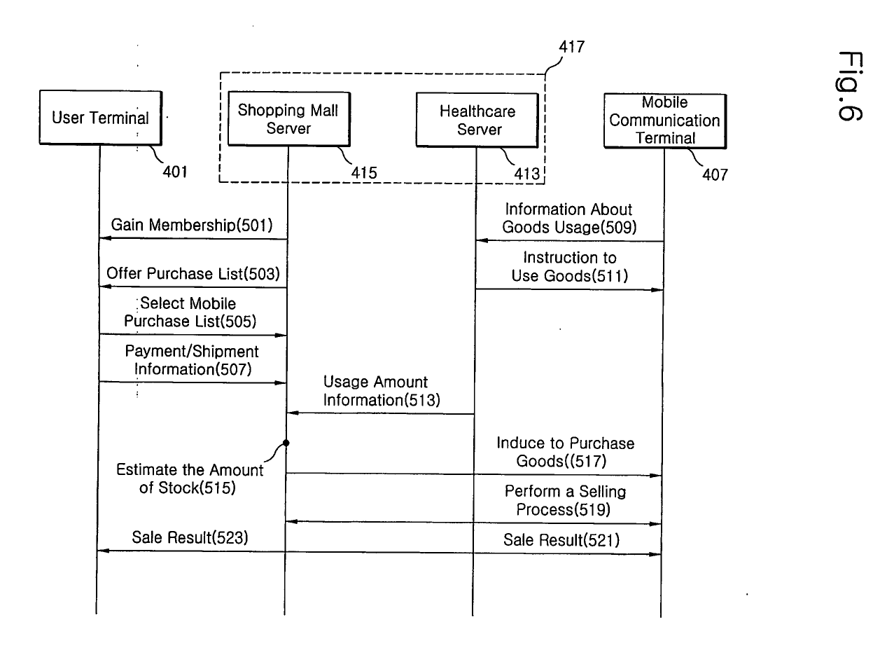

FIG. 6 is a view showing a goods sale/purchase method in accordance with an embodiment of the present invention. A description thereof is now set forth with reference to FIG. 6.

As shown in FIG. 6, the goods sale method using the mobile communication terminal according to an embodiment of the present invention, which can be implemented on the shopping mall server 415, comprises the steps of estimating the amount of stock of each user from goods usage amount information offered by the healthcare server 413 (step 515), transmitting to the mobile communication terminal 407 a signal to induce a corresponding member to purchase goods (step 517), and selling the goods using stored personal information upon receiving a corresponding reply signal from the mobile communication terminal 407.

The shopping mall server 415 receives each member's usage amount information of corresponding goods, which is provided by a healthcare program, from the healthcare server 413. The healthcare server 413 communicates with the member's terminal, i.e., the mobile communication terminal 407 in the present embodiment, to transmit/receive signals associated with medical measurement or medical treatment to each other (steps 509 and 511). Hereinafter, suppose that the member's terminal is the mobile communication terminal 407. The member's terminal may be a wireline terminal.

In one implementation, the healthcare server 413 can provide the usage amount information to the shopping mall server 415 using the signals transmitted/received.

The shopping mall server 415 estimates the amount of stock of each member from the usage amount information (step 515). For example, in case of a 20-pack of goods, the number of stock goods is sequentially counted down from ‘20’ as the usage amount information continuously occurs. If the number of stock goods is ‘6’ and the usage amount information is ‘2’, the number of stock goods is currently estimated to be ‘4’. That is, the number of stock goods is counted down by ‘1’ each time measurement data is received.

For example, if a set threshold value of the stock goods is ‘5’, the shopping mall server 415 transmits to the mobile communication terminal 407 of a corresponding member an inducing signal to induce to purchase corresponding goods (step 517).

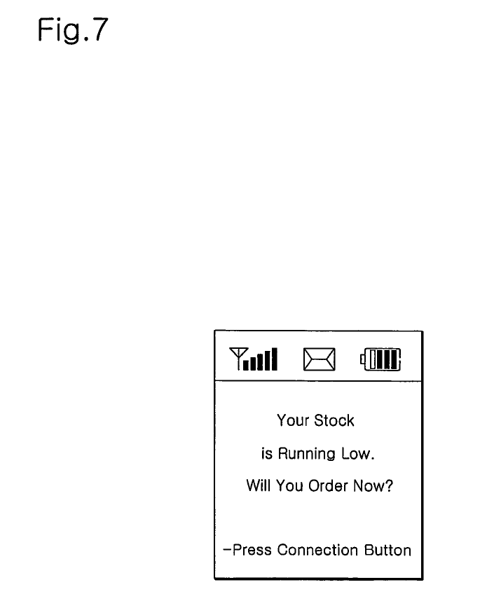

As described above, the inducing signal may be a short text message containing an address of a server on a network (refer to FIG. 7). A technology of sending the inducing signal to the mobile communication terminal 407 through so-called WAP-Push technology is well known in the art and thus a detailed description thereof will not be given herein.

In addition, when a user inputs a key corresponding to ‘a purchase order’ in response to the inducing signal, a reply signal to the inducing signal is sent from the mobile communication terminal 407 to the shopping mall server 415 (step 519). Preferably, at this time, data communication is established between the mobile communication terminal 407 and the shopping mall server 415. A technology where the mobile communication terminal 407 attempts to access a network address contained in a short message and establishes a data communication with the server 415 is well known in the art.

In addition, the shopping mall server 415 performs a selling process of the corresponding goods upon receiving a reply signal from the mobile communication terminal 407 (step 519).

The present invention is characterized in that upon performing a selling process, the shopping mall server 415 does not receive information necessary for sale from the mobile communication terminal 407 but uses stored personal information.

As described above, according to the preferred embodiment of the present invention, a user admitted to a healthcare program can conveniently purchase desired goods without the need to take stock of his/her healthcare goods as long as he/she replies to the inducing signal.

That is, it is not necessary for the user to go out to purchase goods, or to access any wireline/wireless web server using a terminal (personal computer, mobile communication terminal, etc.) to purchase goods. Although the mobile communication terminal 407 is used to purchase goods, the present invention is characterized in that it does not take complex procedures or long times to purchase goods compared to conventional methods. That is, the mobile communication terminal 407 is used only in placing a purchase order of goods based on stocktaking. In addition, for example, the personal information required for mobile payment is entered in advance when a user makes an application for membership admission. Thus, it is not necessary to enter the personal information again upon purchasing goods.

Accordingly, the present invention can be efficiently utilized by old-aged people who are much interested in healthcare. In particular, since healthcare consumables are purchased repeatedly, the present invention can be more efficiently utilized.

The present invention is characterized in that the goods usage amount information is transmitted from a corresponding member's mobile communication terminal 407 to the healthcare server 413 and is obtained from a signal generated when the healthcare consumables are consumed.

The present invention is also characterized in that the goods usage amount information is sent from the healthcare server 413 to a member's terminal 407 and is obtained using an instruction signal to instruct to use the healthcare consumables.

Accordingly, the goods usage amount information can be obtained through various means.

The healthcare server and the member's terminal communicate with each other and transmit/receive signals associated with medical measurement or medical treatment to each other. In an embodiment of the present invention, the goods usage amount information can be obtained using an instruction signal, which is issued by the healthcare server 413, to instruct to use the healthcare consumables. In another embodiment, the goods usage amount information can be obtained from a signal generated by a mobile communication terminal 407 by using the healthcare consumables.

From this point of view, the above-mentioned features specify specific technologies of the healthcare business (combined with digital technologies) to which the present invention can be applied. In addition, the present invention can be applied in such a specific technical configuration.

The present invention is also characterized in that the member's terminal is a mobile communication terminal 407.

As described above, in the present invention, the user's terminal accessed to the healthcare server 413 may be a wireline terminal or wireless terminal. It is desired that the user's terminal is a mobile communication terminal 407.

To use a healthcare service anytime and anywhere, a user's terminal tends to be implemented with a mobile wireless terminal. In recent years, a configuration for medical treatment or medical measurement tends to be combined with a mobile phone. Accordingly, the present invention can be also applied to a case where the member's terminal is a mobile communication terminal.

In addition, the healthcare goods available in a mobile communication terminal can be difficult to find at shopping malls on the street. However, according to the present invention, the user can conveniently purchase such healthcare goods.

The present invention is also characterized in that the goods usage amount information is obtained from the usage cycle of the healthcare consumables.

In this case, the goods usage amount information offered from the healthcare server 413 is usage cycle information (step 513).

The present invention is also characterized in that the step of estimating the amount of stock of each user from the goods usage amount information (step 515) makes reference to the user's purchase information.

In one implementation, the shopping mall server 415 can manage each member's purchase details database and stock database for the purpose of estimating the amount of stock. Typically, the shopping mall server 415 has a function of maintaining purchase details.

First, identification information and quantity information with respect to sold goods can be stored in the purchase details database.

For example, if the sold goods are blood sugar test strips and 2 packs (20 pieces/pack) of the measurement strips have been sold, the shopping mall server 415 writes ‘40’ into the stock database. Thus, upon estimating the amount of the stock, the shopping mall server 415 can make reference to the purchase details database.

In addition, upon estimating the amount of the stock, the sale date in the purchase details database may be looked up. This is suitable for a case where the quantity consumed depends on the usage cycle.

The present invention is also characterized in that the step of estimating the amount of stock of each user (step 515) makes reference to statistics of the amount of stock when each member orders goods.

For example, if a member does not respond to an inducing signal to induce to purchase goods when the number of stock goods is more than 5 but he/she responds when the number of stock goods is less than 5, the server can estimate statistics of the stock goods upon ordering goods by each member. Thus, it is possible to reduce the number of times the inducing signal is sent.

In addition, the present invention is also characterized in that when the number of stock goods is a negative value, the step of estimating the amount of stock of each user from the goods usage amount information (step 515) determines that a member is currently using goods which are not purchased through the shopping mall server, and increases the number of stock goods by purchase unit.

Actually, a user may purchase goods offline. In this case, the number of stock goods is a negative value as the user continues to purchase goods offline. Accordingly, for example, it is desired that the number of stock goods is increased by purchase unit (e.g., 1 pack (20 pieces/pack) of the blood sugar test strips).

The present invention is also characterized in that the personal information is payment information and shipment information preset by a corresponding member.

Accordingly, in case of mobile payment using a mobile communication terminal, it is not necessary to enter the payment and shipment information.

The user may access the shopping mall server 415 or the healthcare server 413 on a web using a user terminal 401 such as a personal computer and enter the payment and shipment information. Alternatively, a salesperson, who promotes a healthcare program and induces to enter the program, may input the payment and shipment information to the shopping mall server 415 or the healthcare server 413.

The present invention is also characterized in that the signal generated by consuming the healthcare consumables is a biometric data report signal generated from the member's terminal.

The present invention is also characterized in that the signal generated by consuming the healthcare consumables is a treatment instruction signal generated from the healthcare server.

As described above, the healthcare server 413 and the member's terminal 407 communicate with each other and transmit/receive signals associated with medical measurement or medical treatment to each other. The above-mentioned features specify specific technologies of the healthcare business (combined with digital technologies) to which the present invention can be applied. In addition, the present invention can be applied in such a specific technical configuration.

For example, the user terminal 407 transmits a biometric data report signal to the healthcare server. At this time, the goods usage amount can be obtained. In more detail, upon measuring blood sugar, blood sugar test strips are used. At this time, the number of the strips consumed can be obtained.

In addition, in a case where the healthcare server 413 sends a treatment instruction signal, it is possible to recognize the consumption amount of corresponding goods.

Meanwhile, in the above-mentioned embodiments, a description has been given of the operations of the shopping mall server 415 and the healthcare server 413. However, while the two servers are functionally or logically divided, they can be physically integrated into a single server 417.

In one implementation, the service server 417 may be a homepage for diabetic patients. This homepage may be one for providing a service to a user who has purchased the mobile communication terminal 407 having diabetic measurement function. This homepage provides information concerning diabetic treatment and a history of blood sugar test, and an analysis report offered by an expert system on the basis of the above-mentioned information. In addition, this homepage can provide shopping mall pages which allow a user to purchase goods necessary to the diabetic patients. For example, the homepage provides links which allow a user to purchase blood glucose meter, blood collection needle, blood collection device, blood sugar test strip, insulin pump, insulin syringe, etc., and provides various goods according to the price and manufacturer. When a user selects a certain link, goods information, such as goods photograph, price, specification, manufacturer, or place of origin, is presented in graphic and text formats.

On the other hand, the shopping mall server 415 can be divided into a wireline shopping mall server, which can access from a number of user terminals 401 over the Internet 403, and a wireless shopping mall server, which can access from a number of mobile communication terminals 407 over the mobile communication network 405 (not shown in FIG. 6).

In one implementation, a user can access the shopping mall server 415 using the user terminal 401 and make an application for membership admission (step 501). At this time, the user may make an application for goods purchase or healthcare program.

In addition, the shopping mall server 415 sends lists of goods to the user terminal 401 (step 503) and allows the user to select one of the lists (step 505).

In addition, in an embodiment of the present invention, the user can enter personal information required in purchasing mobile goods, such as payment and shipment information, to the user terminal 401, and send the personal information to the shopping mall server 415 (step 507).

In FIG. 6, reference numeral 521 indicates that the shopping mall server 415 sends a sale result to the mobile communication terminal 407, and reference numeral 523 indicates that the shopping mall server 415 sends a sale result to the user terminal 401.

### INDUSTRIAL APPLICABILITY

As apparent from the above description, an electronic commerce method over wireline/wireless networks according to the present invention allows a user to conveniently purchase goods anytime and anywhere by using both a convenient user interface over the wireline network and wireless network accessibility.

In addition, in accordance with the present invention, a user admitted to a healthcare program can conveniently purchase desired goods without the need to take stock of his/her goods as long as he/she replies to an inducing signal.

It is not necessary for a user to go out to purchase goods, or to access any wireline/wireless web server using a terminal (personal computer, mobile communication terminal, etc.) to purchase goods. Although the mobile communication terminal is used to purchase goods, the present invention is characterized in that it does not take complex procedures or long times to purchase goods compared to conventional methods. That is, the mobile communication terminal is used only in placing a purchase order of goods based on stocktaking. In addition, for example, the personal information required for mobile payment is entered in advance when a user makes an application for membership admission. Thus, it is not necessary to enter the personal information again upon purchasing goods.

The present invention can be efficiently utilized by old-aged people who are much interested in healthcare. In particular, since healthcare consumables are purchased repeatedly, the present invention can be more efficiently utilized.

While the present invention has been described with reference to exemplary embodiments thereof, it will be understood by those skilled in the art that various changes in form and details may be made therein without departing from the scope of the present invention as defined by the following claims.

1. An electronic commerce method over wireline/wireless networks which can be implemented both in a wireline shopping mall system on a wireline Internet and in a wireless shopping mall system which is linked with the wireline shopping mall system and is accessible over a mobile communication network, the method comprising the steps of:
authenticating a user accessing a wireline shopping mall by the wireline shopping mall system;
allowing the wireline shopping mall system to offer goods information to the user and to receive selection information from the user and adding the selection information to a list of goods to be purchased through a wireless shopping mall;
allowing the wireless shopping mall system to process a connection with a mobile communication terminal;
allowing the wireless shopping mall system to transmit the list of goods to be purchased through the wireless shopping mall to the mobile communication terminal; and
performing a purchasing process of selected goods by the wireless shopping mall system.

2. The electronic commerce method of claim 1, further comprising allowing the wireline shopping mall system to receive membership information including a phone number of the mobile communication terminal and to perform a membership admission procedure.

3. The electronic commerce method of claim 2, wherein the step of allowing the wireless shopping mall system to process a connection comprises identifying a member from a phone number of an accessing mobile communication terminal.

4. The electronic commerce method of claim 1, further comprising allowing the wireline shopping mall system to offer the user a list of payment means to be used in purchasing goods in the wireless shopping mall, to receive selection information from the user, and to store the selection information as payment means to be used in purchasing goods in the wireless shopping mall.

5. The electronic commerce method of claim 1, wherein the step of performing a purchasing process comprises displaying purchase information including ordered goods and delivery destination to the mobile communication terminal so that the user can recognize the purchase information.

6. An electronic commerce method over wireline/wireless networks which can be implemented both in a personal computer accessible to a wireline shopping mall system and in a mobile communication terminal accessible to a wireless shopping mall system, the method comprising the steps of:
allowing the personal computer to access the wireline shopping mall system;
offering a user goods information received from the wireline shopping mall system, and transmitting selection information inputted by the user to the wireline shopping mall system as selection information for goods to be purchased in a wireless shopping mall;
allowing the mobile communication terminal to access the wireless shopping mall system;
allowing the mobile communication terminal to receive the list of goods to be purchased in the wireless shopping mall from the wireless shopping mall system and to display the list of goods; and
transmitting purchase order information for goods selected from among the displayed list of goods by the user to the wireless shopping mall system.

7. The electronic commerce method of claim 6, further comprising allowing the personal computer to receive membership information including a phone number of the mobile communication terminal from the user and to transmit it to the wireline shopping mall system as membership admission information.

8. The electronic commerce method of claim 6, further comprising allowing the personal computer to receive a list of payment means to be used in purchasing goods in the wireless shopping mall from the wireline shopping mall system, to display the list of payment means so that the user can view it, to receive selection information from the user, and to transmit the selection information to the wireline shopping mall system.

9. The electronic commerce method of claim 6, further comprising allowing the mobile communication terminal to receive purchase information including ordered goods and delivery destination from the wireless shopping mall system and to display the purchase information so that the user can recognize it.

10. An electronic commerce method over wireline/wireless networks which can be implemented in a shopping mall accessible over both a wireline Internet and a mobile communication network, the method comprising the steps of:
offering a web page for user authentication to a computer of a user accessing over the wireline Internet and performing an authentication process with reference to information inputted;
offering a web page including goods information to the user, receiving selection information from the user, and adding it to a list of goods to be purchased through the wireless network;
performing an access to a mobile communication terminal of the user over the wireless network;
transmitting the list of goods to be purchased through the wireless network to the mobile communication terminal; and
performing a purchasing process of selected goods in response to the user's purchase order.

11. The electronic commerce method of claim 10, further comprising receiving membership information including a phone number of the mobile communication terminal over the wireline network and performing a membership admission procedure.

12. The electronic commerce method of claim 11, wherein the step of performing an access comprises identifying a member from a phone number of an accessing mobile communication terminal.

13. The electronic commerce method of claim 10, further comprising offering the user accessing over the wireline network a list of payment means to be use in purchasing goods through the wireless network, receiving selection information from the user, and storing the selection information as payment means to be used in purchasing goods over the wireless network.

14. The electronic commerce method of claim 10, wherein the step of performing a purchasing process comprises displaying purchase information including ordered goods and delivery destination to the mobile communication terminal so that the user can recognize the purchase information.

15. An electronic commerce method over wireline/wireless networks which can be implemented both in a personal computer accessible to a shopping mall system over a wireline Internet and in a mobile communication terminal accessible to the shopping mall system over a mobile communication network, the method comprising the steps of:
allowing the personal computer of a user to access the shopping mall system over a wireline network;
allowing the personal computer to offering goods information received from the shopping mall system to the user, and transmitting selection information inputted by the user to the shopping mall system as selection information for goods to be purchased in the wireless shopping mall;
allowing the mobile communication terminal to access the shopping mall system over a wireless network;
allowing the mobile communication terminal to receive a list of goods to be purchased in the wireless shopping mall from the shopping mall system and to display the list of goods; and
transmitting purchase order information for goods selected from among the displayed list of goods by the user to the shopping mall system.

16. The electronic commerce method of claim 15, further comprising allowing the personal computer to receive membership information including a phone number of the mobile communication terminal from the user and to transmit it to the shopping mall system as membership admission information.

17. The electronic commerce method of claim 14, further comprising allowing the personal computer to receive a list of payment means to be used in purchasing goods over the wireless network from the shopping mall system, to display the list of payment means so that the user can view it, to receive selection information from the user, and to transmit the selection information to the shopping mall system.

18. The electronic commerce method of claim 14, further comprising allowing the mobile communication terminal to receive purchase information including ordered goods and delivery destination from the shopping mall system and to display the purchase information so that the user can recognize it.

19. An electronic commerce method over wireline/wireless networks which can be implemented on a shopping mall server, the method comprising the steps of:
estimating the amount of stock of each user from goods usage amount information offered by a healthcare server;
transmitting a signal to induce a corresponding member to purchase corresponding goods to a mobile communication terminal of the member; and
selling the goods using stored personal information upon receipt of a corresponding reply signal from the mobile communication terminal.

20. The electronic commerce method of claim 19, wherein the goods are healthcare consumables.

21. The electronic commerce method of claim 20, wherein the goods usage amount information is transmitted from the corresponding member's terminal to the healthcare server and is obtained from a signal generated by consuming the healthcare consumables.

22. The electronic commerce method of claim 20, wherein the goods usage amount information is transmitted from the healthcare server to the corresponding member's terminal and is obtained from a usage instruction signal to use the healthcare consumables.

23. The electronic commerce method of claim 21, wherein the member's terminal is a mobile communication terminal.

24. The electronic commerce method of claim 22, wherein the member's terminal is a mobile communication terminal.

25. The electronic commerce method of claim 20, the goods usage amount information is obtained from the usage cycle of the healthcare consumables.

26. The electronic commerce method of claim 23, wherein the step of estimating the amount of stock makes reference to the user's purchase information.

27. The electronic commerce method of claim 23, wherein the step of estimating the amount of stock makes reference to statistics of the amount of stock upon ordering goods by each member.

28. The electronic commerce method of claim 23, wherein the personal information is payment information and delivery information predetermined by a corresponding member.

29. The electronic commerce method of claim 23, wherein the signal generated by consuming the healthcare consumables is a biometric data report signal generated from the member's terminal.

30. The electronic commerce method of claim 23, wherein the signal generated by consuming the healthcare consumables is a treatment instruction signal generated from the healthcare server.

31. The electronic commerce method of claim 23, wherein the healthcare consumables are blood sugar test strips.

32. The electronic commerce method of claim 23, wherein the healthcare consumables are insulin.

33. An electronic commerce method over wireline/wireless networks which can be implemented on a shopping mall server and a healthcare server, the method comprising the steps of:
estimating the amount of stock of each member from goods usage amount information;
transmitting a signal to induce a corresponding member to purchase corresponding goods to the member's mobile communication terminal; and
selling the goods using stored membership information upon receipt of a corresponding reply signal from the mobile communication terminal.

34. The electronic commerce method of claim 33, wherein the goods are healthcare consumables.

35. The electronic commerce method of claim 34, wherein the goods usage amount information is transmitted from the corresponding member's terminal to the healthcare server and is obtained from a signal generated by consuming the healthcare consumables.

36. The electronic commerce method of claim 34, wherein the goods usage amount information is transmitted from the healthcare server to the corresponding member's terminal and is obtained from a usage instruction signal to use the healthcare consumables.

37. The electronic commerce method of claim 35, wherein the member's terminal is a mobile communication terminal.

38. The electronic commerce method of claim 36, wherein the member's terminal is a mobile communication terminal.

39. The electronic commerce method of claim 34, the goods usage amount information is obtained from the usage cycle of the healthcare consumables.

40. The electronic commerce method of claim 37, wherein the step of estimating the amount of stock makes reference to the user's purchase information.

41. The electronic commerce method of claim 37, wherein the step of estimating the amount of stock makes reference to statistics of the amount of stock upon ordering goods by each member.

42. The electronic commerce method of claim 37, wherein the personal information is payment information and delivery information predetermined by a corresponding member.

43. The electronic commerce method of claim 37, wherein the signal, generated by consuming the healthcare consumables is a biometric data report signal generated from the member's terminal.

44. The electronic commerce method of claim 37, wherein the signal generated by consuming the healthcare consumables is a treatment instruction signal generated from the healthcare server.

45. The electronic commerce method of claim 37, wherein the healthcare consumables are blood sugar test strips.

46. The electronic commerce method of claim 37, wherein the healthcare consumables are insulin.

47. An electronic commerce method over wireline/wireless networks using a mobile communication terminal which can communicate with a shopping mall server, the method comprising the steps of:
receiving from the shopping mall server a signal to induce a member to purchase corresponding goods on the basis of the amount of stock of each member estimated from goods usage amount information and displaying the signal on a display; and
transmitting a reply signal corresponding to the member's selection and purchasing the goods using membership information stored in the shopping mall server.

48. The electronic commerce method of claim 47, wherein the goods are healthcare consumables.

49. The electronic commerce method of claim 48, wherein the goods usage amount information is transmitted from a corresponding member's terminal to the healthcare server and is obtained from a signal generated by consuming the healthcare consumables.

50. The electronic commerce method of claim 48, wherein the goods usage amount information is transmitted from the healthcare server to the corresponding member's terminal and is obtained from a usage instruction signal to use the healthcare consumables.

51. The electronic commerce method of claim 49, wherein the member's terminal is a mobile communication terminal.

52. The electronic commerce method of claim 50, wherein the member's terminal is a mobile communication terminal.

53. The electronic commerce method of claim 48, the goods usage amount information is obtained from the usage cycle of the healthcare consumables.

54. The electronic commerce method of claim 51, wherein estimating the amount of stock of each member is achieved by referring to the member's purchase information.

55. The electronic commerce method of claim 51, wherein estimating the amount of stock of each member is achieved by referring to statistics of the amount of stock upon ordering goods by each member.

56. The electronic commerce method of claim 51, wherein the membership information is payment information and delivery information predetermined by a corresponding member.

57. The electronic commerce method of claim 51, wherein the signal generated by consuming the healthcare consumables is a biometric data report signal generated from the member's terminal.

58. The electronic commerce method of claim 51, wherein the signal generated by consuming the healthcare consumables is a treatment instruction signal generated from the healthcare server.

59. The electronic commerce method of claim 51, wherein the healthcare consumables are blood sugar test strips.

60. The electronic commerce method of claim 51, wherein the healthcare consumables are insulin.
